(19) United States
(12) Patent Application Publication
(10) Pub. No.: US 2008/0254776 A1
(43) Pub. Date: Oct. 16, 2008

(54) METHOD FOR IMPLEMENTING DO-NOT-DISTURB SERVICE AND INTELLIGENT PHONE TERMINAL

(76) Inventor: Zhangping Ma, Shenzhen (CN)

Correspondence Address: BRINKS HOFER GILSON & LIONE, P.O. BOX 10395, CHICAGO, IL, 60610, US

(21) Appl. No.: 12/145,823

(22) Filed: Jun. 25, 2008

(30) Foreign Application Priority Data
Dec. 28, 2006 (CN) 200610156604.0

(51) Int. Cl. H04M 3/42

(52) U.S. Cl. 455/414.1; 455/415

(57) ABSTRACT

A method for implementing a do-not-disturb service includes: determining, by an intelligent phone terminal, whether to initiate a do-not-disturb service for an incoming call upon detection of the incoming call, the intelligent phone terminal being a fixed phone terminal or a PC software phone terminal provided with human-machine interfaces and capable of processing automatically a call in accordance with a user preset rule; and reading, by the intelligent phone terminal, a do-not-disturb prompt tone file and playing it to the caller of the incoming call if it is determined to initiate a do-not-disturb service. An intelligent phone terminal implements a do-not-disturb service function on an intelligent phone.

This application claims the priority of a Chinese patent application No. 200610156604.0, entitled “Intelligent phone terminal and method for providing do-not-disturb service for the same” and filed with the Chinese Patent Office on Dec. 28, 2006, which is hereby incorporated by reference in its entirety.

### FIELD

The present embodiments relate to implementing a do-not-disturb service and an intelligent phone terminal.

### BACKGROUND

An intelligent phone terminal is a terminal device for phone communication. The intelligent phone terminal is provided with human-machine interfaces and may process automatically a call in accordance with a user preset rule.

A do-not-disturb service includes a service that rejects automatically an incoming call when a person is resting or in a conference. A communication system may reject the incoming call so that the call does not disturb the person. An extended do-not-disturb service may include a “blacklist” and a “VIP list”. The communication system rejects automatically an incoming call from the “blacklist,” but does not reject automatically a call from the “VIP list” regardless of whether it is in a do-not-disturb period.

Currently, popular implementations of the do-not-disturb service include filtering incoming calls on a switch (or a gateway) and filtering incoming calls on a mobile terminal.

Incoming calls may be filtered on a switch (or a gateway). Upon reception of a call request, the switch (or the gateway) determines whether the callee currently registers a do-not-disturb service, and rejects automatically the incoming call without connecting the call request to the callee if the callee registers the do-not-disturb service.

Incoming calls may be filtered on a mobile terminal. The mobile terminal is intelligent and is provided with abundant human-machine interfaces. Accordingly, the mobile terminal is capable of providing the do-not-disturb service. Upon reception of a call request, the mobile terminal determines whether it is necessary to initiate the do-not-disturb service and rejects automatically the incoming call, if necessary.

Currently, fixed phone terminals are increasingly intelligent, and applications of PC software phone terminals are promoted gradually. The do-not-disturb service may be implemented on mobile phone terminals, fixed phone terminals, and PC software phone terminals.

A do-not-disturb service is registered/deregistered for a phone terminal on a switch (or a gateway). The do-not-disturb service is determined by the switch (or the gateway) whether to activate the do-not-disturb service and to reject an incoming call. The process of registering/deregistering the do-not-disturb service is activated from the phone terminal using a private protocol. Upon reception of a call request from a caller, the switch (or the gateway) determines whether the callee registers the do-not-disturb service (or whether it is in a do-not-disturb period at present), and if the callee registers the do-not-disturb service, it rejects connecting to the callee and sends a do-not-disturb prompt tone to the caller. Otherwise, the phone terminal connects normally to the callee.

FIG. 1 is a flow chart of processing a call according to a first method of the related art. The first method of the related art includes the acts shown in FIG. 1. A terminal 1 registers with a switch for a do-not-disturb service through a private protocol. A terminal 2 initiates a call to the terminal 1. The terminal 1 is a callee. When call signaling arrives at the switch, the switch determines that the callee (the terminal 1) registers the do-not-disturb service, then does not connect the call to the callee and responds directly to the caller (the terminal 2) by sending thereto a do-not-disturb prompt tone. The terminal 1 deregisters the do-not-disturb service from the switch through the private protocol. The terminal 2 initiates a call again to the terminal 1 which still acts as a callee. When call signaling arrives at the switch, the switch determines that the callee (the terminal 1) does not register the do-not-disturb service, and then connects normally the call to the terminal 1.

The do-not-disturb service of the first method of the related art is implemented on a switch or a gateway. The terminal 1 has to register the do-not-disturb service through the private protocol, and the compatibility between the terminal and the switch (or the gateway) is not good. Service configuration is not flexible since it is difficult to determine whether to initiate the do-not-disturb service in accordance with a combination of multiple conditions such as a blacklist, a VIP list and a do-not-disturb period and it is difficult for the terminal 1 identify a call which is missed due to the initiated do-not-disturb service so as to call back.

Currently, a mobile phone terminal is highly intelligent, and is provided with abundant human-machine interfaces, thus, a do-not-disturb function may be implemented on a mobile phone terminal, and a blacklist, a VIP list, periods in a daily status and a rest status may be set on the mobile phone terminal.

FIG. 2 is a flow chart of processing an incoming call event by a mobile phone terminal in a second method of the related art. The second method of the related art includes the acts illustrated in FIG. 2. As shown in FIG. 2, the mobile phone terminal detects an incoming call or a short message. It is determined whether the mobile phone terminal is currently in a daily status or a rest status. If in a daily status, the terminal determines whether the calling number is in its blacklist, and if the calling number is in its blacklist, the terminal does not accept the signal of the incoming call or short message; otherwise, the terminal drives a ring or vibrates normally. If in a rest status, the terminal determines whether the calling number is in its VIP list, and if the calling number is in its VIP list, the terminal drives a ring or vibrates normally; otherwise, the terminal does not accept the signal of the incoming call or short message.

However, the second method is only applied to a mobile phone terminal. The second method has a very narrow scope of applications and does not support playing a do-not-disturb prompt tone for a caller.

Furthermore, in the second method, the mobile phone terminal does not accept the signal of the incoming call, and the caller hearing a busy tone may consider that the mobile phone terminal is busy and thus will call repeatedly the user of the mobile phone terminal. Provision of the error information on the user status of the mobile phone terminal to the caller may result in a waste of time and resources of the caller.

### SUMMARY

The present embodiments may obviate one or more drawbacks or limitations inherent in the related art. For example, one embodiment relates to an intelligent phone terminal that is operable to implement a do-not-disturb service on an intelligent phone.

In one embodiment, a method for implementing a do-not-disturb service is provided. The method includes determining, by an intelligent phone terminal, whether to initiate the do-not-disturb service for an incoming call upon detection of the incoming call, the intelligent phone terminal being a fixed phone terminal or a PC software phone terminal provided with human-machine interfaces and capable of processing automatically a call in accordance with a user preset rule; and reading, by the intelligent phone terminal, a do-not-disturb prompt tone file and playing it to the caller of the incoming call if it is determined to initiate the do-not-disturb service.

In another embodiment, an intelligent phone terminal includes a do-not-disturb service determination module adapted to determine whether to initiate a do-not-disturb service for an incoming call when the intelligent phone terminal detects the incoming call; and a do-not-disturb service module adapted to instruct the intelligent phone terminal to read a do-not-disturb prompt tone file and play it to the caller of the incoming call if the do-not-disturb service determination module determines to initiate a do-not-disturb service.

The intelligent phone terminal may determine to initiate the do-not disturb service for the incoming call, and play a do-not-disturb prompt tone to the caller. The prompt tone notifies the caller that the user of the intelligent phone terminal does not wish to be disturbed. The caller may contact the user of the intelligent phone terminal at other appropriate time. that the intelligent phone terminal does not disturb the user of the intelligent phone terminal when necessary, so as to meet the personalized requirement of the user, and ensures the efficiency of the caller for contacting the user of the intelligent phone terminal.

In another embodiment, a method for implementing a do-not-disturb service is provided. The method includes receiving an incoming call from a caller; determining whether a user preset rule indicates that the user receiving the phone call is busy; initiating a do-not-disturb service for the incoming call when the user preset rule indicates the user receiving the phone call is busy; reading a do-not-disturb prompt tone; and playing the do-not-disturb prompt tone to the caller of the incoming call when the do-not disturb service is initiated.

The incoming call may be automatically answered without activating an audio input/output device. The calling number of the incoming call may be associated with a deny exception or an accept exception. The do-not-disturb prompt may be always played to callers with calling numbers associated with a deny exception and normal call processing may be initiated when the calling number is associated with an accept exception.

### BRIEF DESCRIPTION OF THE DRAWINGS

FIG. 1 illustrates a flow chart of processing a call according to a first method in the related art;

FIG. 2 illustrates a flow chart of processing an incoming call event by a mobile phone terminal according to a second method in the related art;

FIG. 3 illustrates one embodiment of a software structure of an intelligent terminal;

FIG. 4 illustrates a flow chart of one embodiment of a do-not-disturb service;

FIG. 5 illustrates a flow chart of one embodiment of a method for providing an intelligent phone terminal with a do-not-disturb service; and

FIG. 6 illustrates a block diagram of one embodiment of an intelligent phone terminal.

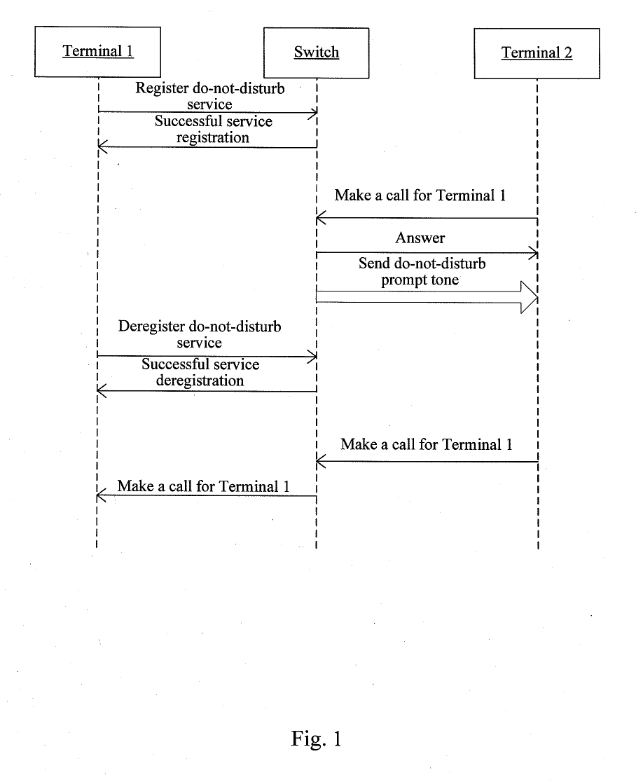

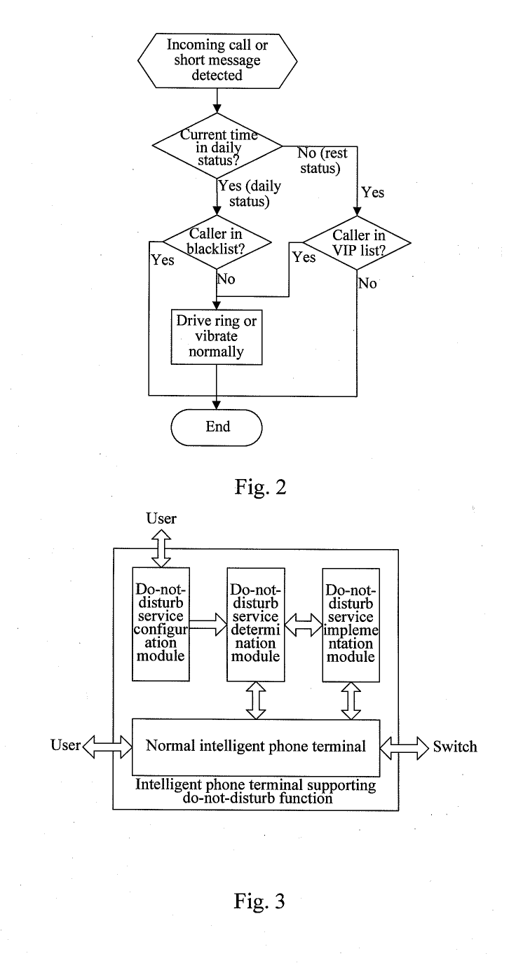

### DETAILED DESCRIPTION

FIG. 3 illustrates one embodiment of an intelligent phone terminal. This intelligent phone terminal may be a fixed phone terminal or a PC software phone terminal provided with human-machine interfaces and capable of processing automatically a call in accordance with a user preset rule. The intelligent phone terminal may include a software structure that includes modules and functions illustrated in FIG. 3.

As illustrated in FIG. 3, the intelligent phone terminal may include a normal intelligent phone terminal. A do-not-disturb service module is added on to the normal intelligent phone terminal, so as to implement a do-not-disturb service function. The do-not-disturb service module includes a do-not-disturb service configuration module, a do-not-disturb service determination module, and a do-not-disturb service implementation module.

The normal intelligent phone terminal is provided with call-in and call-out functions. The normal intelligent phone terminal may be a mobile phone terminal, an intelligent fixed phone terminal or a PC software phone terminal. The normal intelligent phone terminal automatically invokes the do-not-disturb service determination module upon detection of an incoming call.

The do-not-disturb service configuration module may be configured by a user with a blacklist, a VIP list, and/or a do-not-disturb period. The do-not-disturb service configuration module may include an exception, such as an accept exception or a decline exception. The do-not-disturb service configuration module may provide the do-not-disturb service determination module with an interface (the interface is used for determining whether a number is in the blacklist or the VIP list or whether the current time is in the do-not-disturb period).

The do-not-disturb service determination module determines whether it is necessary to initiate the do-not-disturb service for an incoming call upon reception of the incoming call. If not necessary, the terminal processes the call as in a normal flow. However, if necessary, the terminal invokes the do-not-disturb implementation module to implement the do-not-disturb service. Determining whether it is necessary to initiate the do-not-disturb service may include reading a user preset rule. The user preset rule may be a presence rule or an availability rule. For example, the user preset rule may be “busy.” When the user preset rule is “busy,” the do-not-disturb service may be initiated.

The do-not-disturb service implementation module implements the do-not-disturb service through invoking an answer interface, a tone play (e.g., play a do-not-disturb prompt tone to a caller) interface, and a log interface of the phone terminal. The do-not-disturb service may be a notification service that notifies a caller when the callee is not available. For example, the notification service may notify the caller when the callee not available to receive incoming calls.

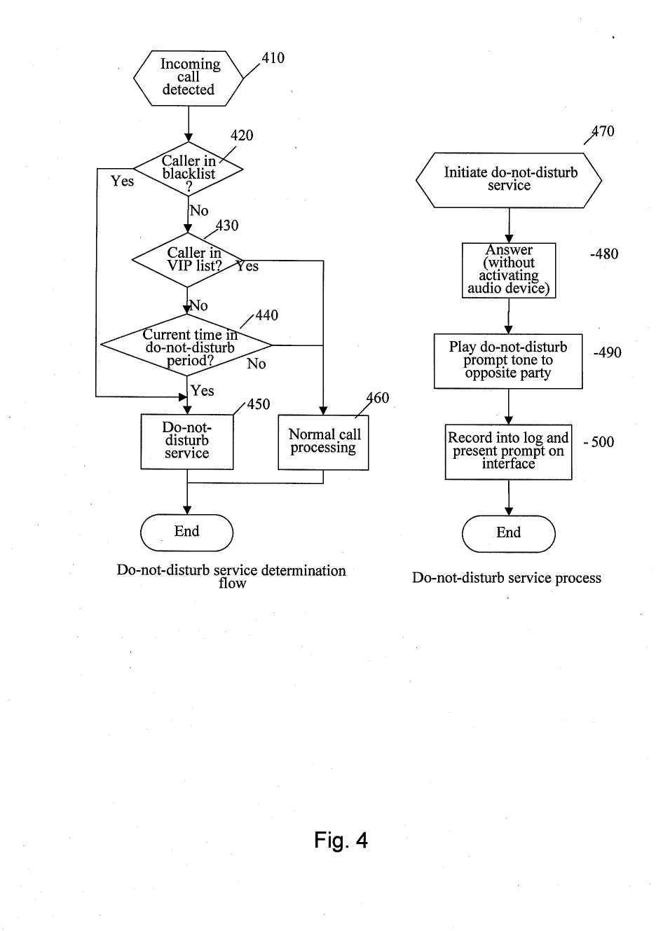

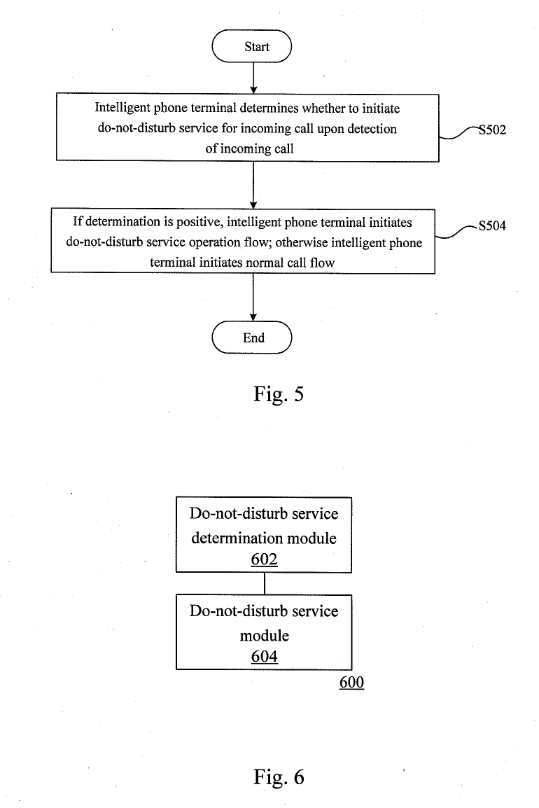

FIG. 4 and FIG. 5 illustrate a method for implementing a do-not-disturb service. FIG. 4 illustrates a flow chart of one embodiment of a do-not-disturb service. FIG. 5 illustrates a flow chart of one embodiment of a method for providing an intelligent phone terminal with a do-not-disturb service.

FIG. 5 illustrates a method for providing an intelligent phone terminal with a do-not-disturb service. At block S502, the intelligent phone terminal determines whether to activate the do-not-disturb service for an incoming call upon detection of the incoming call. At block S504, if it is determined to activate the do-not-disturb service, the intelligent phone terminal initiates a do-not-disturb service operation flow. Optionally, if it is determined not to activate the do-not-disturb service, the intelligent phone terminal initiates a normal call flow.

FIG. 4 illustrates a do-not-disturb service determination process. At block 410, the terminal detects an incoming call and initiates a do-not-disturb service determination flow. At block 420, the intelligent phone terminal determines whether the calling number is in a blacklist of the intelligent phone terminal. If the calling number is in the blacklist (yes), the intelligent phone terminal initiates the do-not-disturb service at block 450. The blacklist may be a list of callers that are blocked. Otherwise, at block 430, the intelligent phone terminal determines whether the calling number is in a VIP list. The VIP list may be a list of callers that are accepted, even if the do-not-disturb service is initiated. If the calling number is in a VIP list (yes), the intelligent phone terminal processes the call as in a normal flow (block 460). Otherwise, at block 440, the intelligent phone terminal determines whether the current time is in a preset do-not-disturb period. If the current time is in a preset do-not-disturb period (yes at block 440), the terminal initiates the do-not-disturb service at block 450. Otherwise, the intelligent phone terminal processes the call as in the normal flow at block 460.

As shown in FIG. 4, the do-not-disturb service process may include the intelligent phone terminal detecting an incoming call and determining that it is necessary to initiate the do-not-disturb service (block 470). At block 480, the intelligent phone terminal may answer automatically the incoming call without activating an audio input/output device. The intelligent phone terminal reads a do-not-disturb prompt tone file and plays it to the caller at block 490. The intelligent phone terminal writes the do-not-disturb event into a log (e.g., including the time and/or the calling number) and presents a prompt on the interface of the terminal at block 500.

FIG. 6 illustrates a block diagram of one embodiment of an intelligent phone terminal 600. As illustrated in FIG. 6, the intelligent phone terminal 600 includes a do-not-disturb service determination module 602 and a do-not-disturb service module 604. The do-not-disturb service determination module 602 is operable to determine whether to initiate a do-not-disturb service for an incoming call when the intelligent phone terminal detects the incoming call. The do-not-disturb service module 604 is operable to instruct the intelligent phone terminal to provide the do-not-disturb service for the incoming call if the do-not-disturb service determination module determines to initiate a do-not-disturb service.

The do-not-disturb service may be implemented on the intelligent phone terminal and may not require special support from a switch or gateway, which results in good compatibility. The do-not disturb service may be used flexibly in that a blacklist, a VIP list, and a do-not-disturb period may be set. The intelligent phone terminal may determine whether to initiate the do-not-disturb service in accordance with a combination of the blacklist, the VIP list, and the do-not-disturb period. When the do-not-disturb service is initiated, the caller may hear a do-not-disturb prompt tone, which shows a friendly use of the service. A do-not-disturb service log provides a call-back log. The method may be applied to various intelligent phone terminals and mobile phones.

Evidently, those skilled in the art shall appreciate that the respective modules or acts may be implemented by a general-purpose computing device and may be integrated on a single computing device or distributed over a network consisted of a plurality of computing devices. Optionally, they may be implemented using program codes executable by the computing device so that they may be stored in a storage device for execution by the computing device or they may be implemented by fabricating them into respective integrated circuit modules respectively or by fabricating some modules or steps of them into a single integrated circuit module. Thus, the invention is not limited to any specific combination of hardware and software. It shall be appreciated that variations of these specific implementations will be obvious to those skilled in the art without departing from the spirit and scope of the invention.

The foregoing descriptions are merely illustrative of the preferred embodiments but not intended to limit the scope of the claims, and various modifications and variations which may be made to the invention will occur to those skilled in the art. Any modifications, equivalent alternatives and adaptations in light of the spirit and principle of the invention shall fall within the scope of the invention.

1. A method for implementing a do-not-disturb service, the method comprising:
determining whether to initiate a do-not-disturb service for an incoming call upon detection of the incoming call using an intelligent phone terminal operable to process a call in accordance with a user preset rule;
reading a do-not-disturb prompt tone; and
playing the do-not-disturb prompt tone to the caller of the incoming call if it is determined to activate a do-not-disturb service for an incoming call upon detection of the incoming call.

2. The method according to claim 1, further comprising: answering automatically the incoming call without activating an audio input/output device.

3. The method according to claim 1, wherein determining comprises:
determining whether the calling number of the incoming call is in a blacklist, and initiating the do-not-disturb service when the calling-number of the incoming call is in a blacklist.

4. The method according to claim 3, wherein the blacklist is stored in a memory of the intelligent phone terminal.

5. The method according to claim 1, wherein determining comprises:
determining whether the calling number of the incoming call is in a VIP list, and initiating a normal call processing when the calling number of the incoming call is in a VIP list.

6. The method according to claim 5, wherein the VIP list is stored in a memory of the intelligent phone terminal.

7. The method according to claim 1, wherein determining comprises:
determining whether the current time is in a do-not-disturb period, and initiating the do-not-disturb service when the current time is in a do-not-disturb period.

8. The method according to claim 7, wherein the do-not-disturb period is stored in a memory of the intelligent phone terminal.

9. The method according to claim 1, further comprising: writing a do-not-disturb event into a log.

10. The method according to claim 1, further comprising: presenting a prompt of a do-not-disturb event on an interface of the intelligent phone terminal.

11. An intelligent phone system, comprising:
an intelligent phone terminal operable to detect an incoming call, the terminal comprising:
a do-not-disturb service determination module adapted to determine whether to initiate a do-not-disturb service for an incoming call when the incoming call is detected; and
a do-not-disturb service module adapted to cause the intelligent phone terminal to read a do-not-disturb prompt tone file and play it to the caller of the incoming call if the do-not-disturb service determination module determines to initiate a do-not-disturb service for an incoming call when the intelligent phone terminal detects the incoming call.

12. The intelligent phone terminal according to claim 11, further comprising a module adapted to answer automatically the incoming call without activating an audio input/output device.

13. The intelligent phone terminal according to claim 11, further comprising a module adapted to write a do-not-disturb event into a log.

14. The intelligent phone terminal according to claim 11, further comprising a module adapted to present a prompt of a do-not-disturb event on an interface of the intelligent phone terminal.

15. The method of claim 15, wherein the intelligent phone terminal is a fixed phone terminal or a PC software phone terminal provided with a human-machine interface.

16. A method for implementing a do-not-disturb service, the method comprising:
receiving an incoming call from a caller;
determining whether a user preset rule indicates that the user receiving the phone call is not available to receive an incoming call;
initiating a do-not-disturb service for the incoming call when the user preset rule indicates the user receiving the phone call is not available to receive an incoming call;
reading a do-not-disturb prompt tone; and
playing the do-not-disturb prompt tone to the caller of the incoming call when the do-not disturb service is initiated.

17. The method according to claim 16, further comprising: answering automatically the incoming call without activating an audio input/output device.

18. The method according to claim 16, further comprising: determining whether the calling number of the incoming call is associated with an accept exception or a block exception.

19. The method according to claim 18, further comprising: playing the do-not-disturb prompt tone to the caller of an incoming call associated with a block exception.

20. The method according to claim 18, further comprising: foregoing the playing the do-not-disturb prompt tone and initiating a normal call processing when the calling number of the incoming call is associated with the accept exception.
